(19) United States
(12) Patent Application Publication
(10) Pub. No.: US 2005/0008133 A1
(43) Pub. Date: Jan. 13, 2005

(54) Method and apparatus for validating an identity

(76) Inventors: Kenneth A. Liu, Whippany, NJ (US); Han Wang, Morris Plains, NJ (US)

Correspondence Address: LAW OFFICE OF JOHN LIGON, 505 HIGHLAND AVENUE, P.O. BOX 43485, UPPER MONTCLAIR, NJ, 07043, US

(21) Appl. No.: 10/617,937

(22) Filed: Jul. 11, 2003

(51) Int. Cl. H04M 15/00; H04M 1/64

(52) U.S. Cl. 379/114.14; 379/88.1

(57) ABSTRACT

The invention is directed to a methodology for validating user identities. A user telephone number is registered, and in a subsequent communications link, the registered telephone number is obtained. A user may provide the registered telephone number by directly inputting the number via the communications link, or the registered number may be obtained from signaling information provided in connection with the establishment of the communications link. A security code established at the time of registration of the user telephone number, and associated with that number, is then obtained from the user via the communications link. After both the registered telephone number and the security code have been obtained, they are processed in a manner to identify a validation status of the user.

### BACKGROUND OF THE INVENTION

Interactive Voice Response (IVR) is a telephone technology that provides a user with the ability to interact with an information database via the telephone. An IVR system prompts the user for information and the user responds to the IVR system prompts. As voice recognition and natural language processing technology has advanced in recent years, IVR systems have also been provided with the ability to interpret users' spoken words. For example, a user can select menu option 3 by speaking the number “three.”, or may interact with the IVR system by speaking a zip code or social security number, etc. In turn, the IVR system processes the users' responses and returns appropriate IVR system voice responses.

Unfortunately, because of the ease of use and easy access to the IVR systems provided through the telephone system, such IVR systems are unusually vulnerable to so-called “spamming”. Spamming is described as sending undesired messages or mail to multiple recipients, often in bulk. It is a sort of electronic equivalent to junk mail. For example, an electronic device can be programmed to repeatedly call an IVR system and manipulate the system leaving multiple undesired messages. A large quantity of such calls can unnecessarily consume processing capacity, storage capacity and/or communications bandwidth.

In addition, for many IVR applications, an institution providing the IVR for customer access may want to limit access to sensitive information to authorized users and/or restrict an unauthorized user's ability to perform particular transactions using the IVR. Nonetheless, calls made to an IVR system that authenticates callers based on the originating telephone number may unwittingly permit fraudulent or unauthorized transactions, orders, or input to proprietary data. This can occur if an unauthorized user places a call from an otherwise-authorized telephone or provides the IVR system with a falsified telephone number that is acceptable to the IVR system.

IVR systems are particularly vulnerable to such unauthorized and/or undesired access in connection with callers using mobile and cellular telephone systems. One reason is the high incidence of theft of cellular telephones. Unauthorized users can use stolen telephones with valid telephone numbers to gain access to an IVR systems and possibly engage in a prohibited interaction with a database accessible from the IVR system based on the identity of the calling number. In addition, there appears to be a thriving practice, albeit illegal, of reprogramming wireless telephones so that the reprogrammed or cloned telephone operates as if it were an authorized telephone, thereby creating an additional opportunity for unauthorized IVR access.

Many IVR systems, of course, take advantage of signaling information provided by the telephone companies known as automatic number identification (ANI), that automatically provides the originating telephone number of an incoming call to the called station or system (e.g., the IVR system). However, such ANI authentication is still subject to fraudulent manipulation, particularly in the case of wireless phones, and additionally limits access for a user of an IVR system to only one telephone.

### SUMMARY OF THE INVENTION

The invention is particularly useful with respect to applications of IVR technology. Embodiments of the invention operating as a host terminal device provide an automated method for validating a user telephone number or identity. According to the methodology of the invention, a user is initially registered with the host terminal. During the course of the user registration, the user identifies a telephone number for registration, at which calls between the user and the host terminal may be initiated or received. The host terminal then generates, and provides to the user, an authentication code associated with the registered user telephone number.

At a subsequent time point, the host terminal device receives a telephone call from a user, and operates to either automatically determine the calling number or to prompt the user placing the telephone call for a registered telephone number. The host terminal then prompts the user to provide the authentication code associated with the registered telephone number and evaluates the provided registered telephone number and authentication code against stored values established at an initial registration of the user. If a proper match is determined by the host terminal, the user identity is validated, and the user is permit access to desired information and/or processing available via the host terminal.

Through operation of the user-authentication methodology of the invention, unauthorized users are prevented from entering an incorrect telephone number or purposely (possibly maliciously) entering another party's telephone number. In addition to providing improved access control, the methodology of the invention also supports a mechanism for providing remote (e.g., from a telephone other than the user's registered telephone) validation as well.

In a further embodiment, the authentication methodology of the invention also can support authentication of data input to the host terminal device—e.g., validation of telephone numbers used as input values.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views.

FIG. 1 schematically depicts a system for validating a user telephone number according to the invention.

FIG. 2 is a flow chart of a procedure for validating a user telephone number according to the method of the invention.

### DETAILED DESCRIPTION

The invention is directed to a method and system for authenticating the identity of a party in communication with a host terminal via a communications medium such as a landline or wireless telephone system. For the hereafter described exemplary embodiment of the invention, it is generally assumed that the Host Terminal incorporates an IVR system to automate portions of the Host-User interaction, but it should be apparent that the methodology of the invention is equally applicable to a host system in which the interaction with the remote party is handled wholly or in part by a live operator.

Validation or authentication of a user's identity and/or telephone number serves a variety of useful purposes. For example, validation of a user telephone number may be applied to limit access to authorized users and/or to reduce the consequences of “spamming” (e.g. reception of unwanted user input). It may also be applied to improve upon the accuracy of user telephone numbers used for a variety of data collection purposes. The functions performed by the invention are also valuable in telephone voice response applications that permit user access from multiple locations. And, the invention is particularly useful in mobile telephone environments which experience a high level of user mobility and which are also more susceptible to unauthorized modifications of telephone numbers and related abuses.

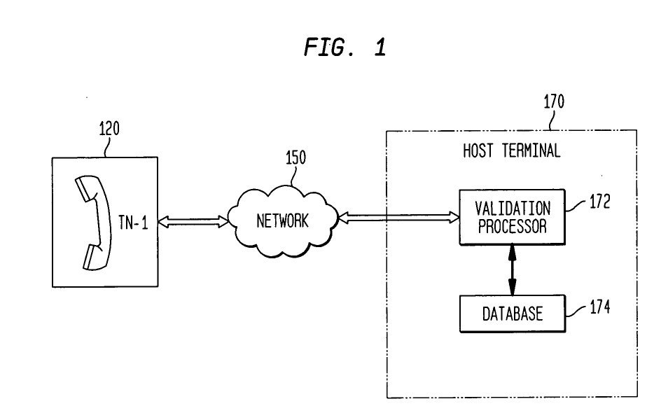

An exemplary system for implementation of the invention is shown schematically in FIG. 1. With reference to the figure, the system includes a User Terminal 120, having an associated network number “TN-1,” a Communications Network 150, such as the U.S. Public Switched Telephone Network (PSTN), and a Host Terminal 170 incorporating an IVR system. The Host Terminal further includes Processor 172, established to provide a user validation status according to the invention, and a Database 174 interconnected with the Processor 172.

In the operation of the invention, a User Terminal first registers with the Host Terminal. Such registration may be by means of a call to the Host Terminal via Communications Network 150, via an internet access to the Host Terminal, or by other means known in the art. As part of the registration process, the Host Terminal generates, and provides to the User Terminal, a user security code which is associated with the network number TN-1 of the User Terminal. Both the User Terminal network number and the associated security code are stored in Database 174.

Upon the establishment of a communications link between the User Terminal and the Host Terminal at a later time, the Host Terminal analyzes the identity of the User Terminal to determine its validity, or authenticity, for whatever purpose the communications link was established. Based on that authenticity determination, the Host Terminal either continues or discontinues further processing of the call. Note that either the Host Terminal or the User Terminal may initiate the communications link.

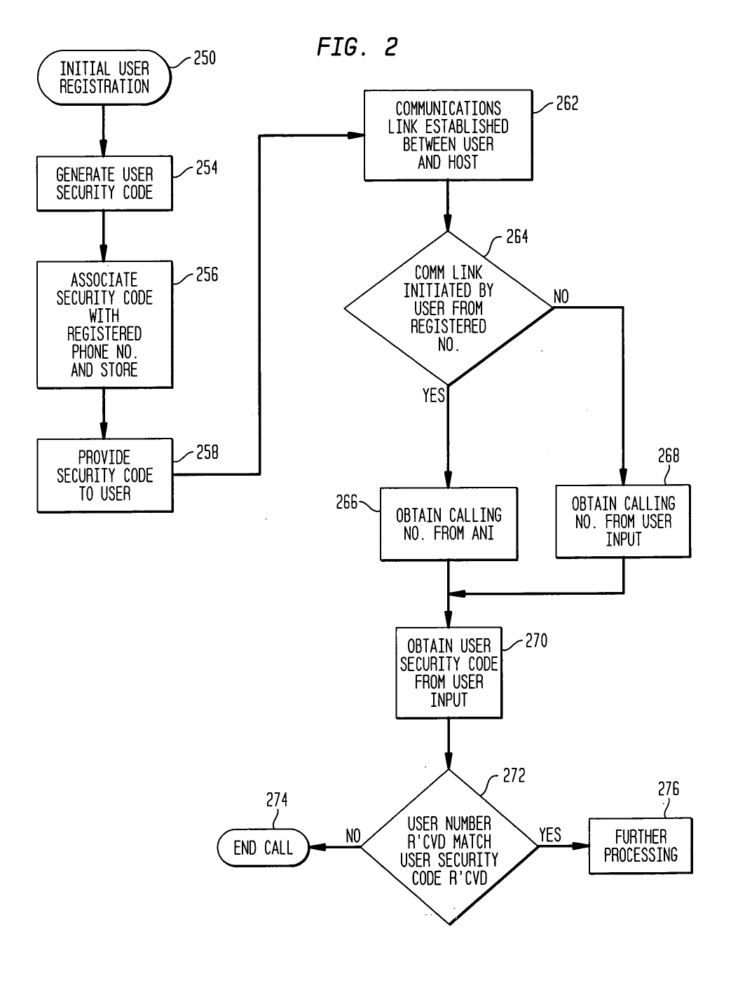

The process by which the Host Terminal carries out the objectives of the invention is illustrated in the flow chart of FIG. 2. With reference to that flow chart, the process begins at Step 250 with the initiation of User Registration for a user wishing to register with the Host Terminal. In the course of User Registration, the user identifies a telephone number at which calls between the user and the Host Terminal may be initiated or received. Next, at Step 254, the Validation Processor of the Host Terminal operates to generate a User Security Code for the user and, at Step 256, the generated User Security Code is associated with the phone number registered by the user. As previously indicate, that association relationship for each user is stored in the Database associated with the Validation Processor. To complete the user registration process, the user is provided with the generated Security Code, at Step 258, and advised that the Security Code will be required to validate future communications sessions with the Host Terminal.

At some future time, a new communications link is established between the user and the Host Terminal, at Step 262. For example, the user may contact the Host Terminal to obtain information purchased on a subscription basis. In the following decision step (Step 264), alternate processing steps are determined, depending upon the source of the call. If the communications link, or call, is initiated by the user from the registered telephone number (Step 266), the calling telephone number is obtained by the Host Terminal via Automatic Number Identification (ANI) provided by the network handling the call. Alternatively, if the call is initiated by the Host Terminal, or by the user from a number other than the registered telephone number (Step 268), the registered number is obtained by the Host Terminal via user input. Such user input may be provided, for example, by keying in the number at the user's terminal, or by speaking the number—for translation by a speech processing function at the Host Terminal. The case of a user-initiated call from other than the registered number may represent the user calling from a wireless phone, or possibly from a landline phone at other than the user's normal location. In such cases, the authentication process of the invention is particularly necessary. [It should, of course, be understood that the eventuality of the communication network not providing ANI in respect to a user-initiated call from the registered telephone number would cause the method of the invention to revert to Step 268 for determining the registered telephone number.]

Once the registered telephone number is obtained by the Host Terminal, at Steps 266 or 268, the user is prompted to supply the Security Code previously assigned for the registered telephone number, at Step 270. As with Step 268, user input of the Security Code to the Host Terminal may be by any known method, and would typically be done by keying the alpha-numeric characters of the Security Code at the user's terminal, or by speaking those characters for recognition by a speech processing function at the Host Terminal.

In Step 272, the Validation Processor of the Host Terminal processes the combination of the received registered telephone number and the user-provided Security Code to identify a validation status of the user then in communication with the Host Terminal. To process the validation status, the Validation Processor may use an algorithm or table look-up to determine if the user then in communication with the Host Terminal is authorized for the processing requested from the Host Terminal. If a proper match is determined between the registered telephone number and the received Security Code, the user is permitted to go forward with the requested further processing, at Step 276. If, however, the Validation Processor does not determine a proper match between the registered number and the Security Code, the communications link is terminated, at Step 274.

It should be understood from the foregoing description of the process of the invention that the communications link between the Host Terminal and a registered user can advantageously be initiated by either the Host or the user. In the case of Host-initiated calls, an exemplary application of the invention would be subscription services in which calls are placed from a service provider, via the host terminal, to subscribing users—such as for periodic reports or reminders—and for which the service provider needs to validate recipients as actual subscribers of the service. In the case of user-initiated calls, a typical application of the invention would be for control of user access to confidential or proprietary data stored in a database accessed via the Host Terminal, where authentication of a user seeking access to such data is essential to protecting the data from access by unauthorized parties.

In a further illustrative application, the Host Terminal may call a user at an alternate telephone number (i.e., other than the registered number) where the Host Terminal expects the user to be located. Upon receiving an answer at the called number, the Host Terminal prompts the recipient of the call for the registered telephone number of the called user and for the security code associated with the registered telephone number, in order to authenticate the called user's identity.

While this invention has been particularly shown and described with reference to preferred embodiments thereof, it will be understood by those skilled in the art that various changes in form and details may be made therein without departing from the spirit and scope of the invention as defined by the appended claims.

For example, although the invention is described largely in terms of automated operations, it should be apparent that the process of the invention could also be implemented through interactions with a human telephone operator.

Other arrangements of embodiments of the invention that are disclosed herein include software programs to perform the method embodiment steps and operations disclosed in detail above. It is to be understood that the system of the invention can be embodied strictly as a software program, as software and hardware, or as hardware alone.

1. A method for validating a user identity via a communications link comprising the steps of:
obtaining a registered user telephone number coincident with set up of the communications link;
obtaining a pre-assigned security code associated with the registered user telephone number from a user connected to the communications link;
processing the registered user telephone number and the security code to determine a validation status of the user.

2. The method of claim 1 comprising the steps, preceding the step of obtaining a registered telephone number, of:
receiving a user telephone number for registration;
generating the security code associated with the user telephone number received for registration; and
linking the user telephone number received for registration and the associated security code in a data base.

3. The method of claim 1 wherein the registered user telephone number is obtained from signaling information provided in conjunction with the communications link.

4. The method of claim 1 wherein the registered user telephone number is obtained from information input to the communications link by the user.

5. The method of claim 1 wherein the communications link is established by a call initiated by the user.

6. The method of claim 1 wherein the communications link is established by a call initiated by a terminal other than a terminal associated with the user.

7. A telecommunications device for validating a user identity via a communications link comprising:
a means for obtaining a registered user telephone number coincident with set up of the communications link;
a means for obtaining a pre-assigned security code associated with the registered user telephone number from a user connected to the communications link;
a processor for processing the registered user telephone number and the security code to determine a validation status of the user.

8. The device of claim 7 further comprising:
registration means for receiving a user telephone number for registration;
a processor for generating the security code associated with the user telephone number received for registration; and
a data base in which a linkage between the user telephone number received for registration and the associated security code is stored.

9. The device of claim 7 wherein the registered user telephone number is obtained from signaling information provided in conjunction with the communications link.

10. The device of claim 7 wherein the registered user telephone number is obtained from information input to the communications link by the user.

11. The device of claim 7 wherein the communications link is established by a call initiated by the user.

12. The device of claim 7 wherein the communications link is established by a call initiated by a terminal other than a terminal associated with the user.

13. A telecommunications device, for validating a user identity comprising:
a database;
a validation processor;
means for coupling the database and the validation processor;
means, coupled to the validation processor, for obtaining a registered user telephone number;
means, coupled to the validation processor, for obtaining, from a user, a security code associated with the registered user telephone number;
wherein the validation processor operates on the obtained registered telephone number and the security code to determine a validation status of the user identity.

14. A stored program provided on a computer readable medium having instructions stored thereon for validating a user identity, the method comprising the steps of:
obtaining a registered user telephone number;
obtaining, from a user, a security code associated with the registered user telephone number;
processing the registered user telephone number and the security code to identify a validation status of the user identity.
